(19) United States
(12) Patent Application Publication
(10) Pub. No.: US 2009/0305184 A1
(43) Pub. Date: Dec. 10, 2009

(54) MECHANICAL TRANSDUCTION CYCLIC FORCE ORTHODONTIC SYSTEM

(76) Inventors: Kang Ting, Beverly Hills, CA (US); Chia Soo, Beverly Hills, CA (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/278,147

(22) PCT Filed: Feb. 1, 2007
(86) PCT No.: PCT/US07/02808

§ 371 Date: Jun. 5, 2009

Related U.S. Application Data
(60) Provisional application No. 60/764,810, filed on Feb. 3, 2006.

(51) Int. Cl. A61C 7/06; A61C 3/00

(52) U.S. Cl. 433/24; 433/5

(57) ABSTRACT

Provided herein is a transduction cyclic force system for moving and/or repositioning teeth.

### FIELD OF INVENTION

The present invention generally relates to using a cyclic force system for moving teeth, optionally towards a predefined pattern and/or position.

### BACKGROUND OF THE INVENTION

Orthodontics involves the use of mechanical forces to move teeth within the jaw bone and therefore, relies on force-induced bone remodeling. A force is a physical quantity and has several essential properties such as the magnitude, direction, point of application and frequency. All these properties of orthodontic forces have been subjects of scientific research and considered in clinical practice of orthodontics with the exception of force frequency. Exclusive use of continuously applied static forces in orthodontics and the resulting lack of consideration of force frequency contradict the overall scientific consensus-based evidence obtained from orthopedic studies of long bones that cyclic forces induce more effective bone remodeling than static forces of matching magnitude.

The current orthodontic technology uses continuously applied static forces to move the teeth towards predetermined positions to achieve esthetically pleasing look is its predictable, albeit slow, outcome, inducing controlled tooth movement towards predetermined position when treatment is carried out by a competent orthodontist. However, the current orthodontic technology takes a relatively long period of time, which causes inconveniences to the patient and can be a financial burden.

Although rapid cyclic forces; i.e., forces with rapidly varying magnitude over time have been proposed to induce more rapid tooth movement (U.S. Pat. Nos. 6,832,912 and 6,648,639) than the presently used continuous forces, these devices are impractical to use. Therefore, there is a need for new orthodontic technologies.

The following embodiments address the above identified problems and needs.

### SUMMARY OF THE INVENTION

Provided herein is a transduction cyclic force system for facilitating tooth movement. The cyclic force system includes a transducer material which, upon exposure to a stimulus such as electricity or a magnetic field, generates a cyclic force, thereby providing a stimulation that facilitates tooth movement. Optionally, the cyclic force can be applied with a realigning force on the tooth/teeth in the direction of realignment.

The transducer material can be any material capable of generate a cyclic force upon exposure to a stimulus (e.g., electricity or a magnetic field). Such transducer material can be, for example, a piezoelectric material which can be crystals, ceramics, polymers, or combinations thereof. In some embodiments, the material capable of generating a cyclic force can be a composite that includes any of the transducer materials.

The cyclic force system provided herein can be used in orthodontics for moving tooth/teeth, optionally to a predetermined position.

### DETAILED DESCRIPTION OF THE INVENTION

Provided herein is a transduction cyclic force system for facilitating tooth movement. The cyclic force system includes a transducer material which, upon exposure to a stimulus such as or a magnetic field, generates a cyclic force, thereby providing a stimulation that facilitates tooth movement.

In some embodiments, the cyclic force can be applied with a realigning force on the tooth/teeth in the direction of realignment.

In some embodiments, the cyclic force described herein can be applied on a tooth/teeth for moving the tooth/teeth without a realigning force tooth/teeth.

### Stress-Strain Related Bone Regeneration

As described in Meyer, U. et al. Biomechanical and clinical implications of distraction osteogenesis in craniofacial surgery. J Craniomaxillofac Surg 32, 140-9 (2004), bone has an adaptive behavior toward a changing mechanical environment, which is regarded as phenotype plasticity. Specific strain-dependent signals are thought to control this adaptive mode of bony tissue modeling. The adaptive mechanisms include basic multicellular units (BMUs) of bone remodeling. Effector cells within BMUs have been shown to function in an interdependent manner. While hormones may bring about as much as 10% of the postnatal changes in bone strength and mass, 40% are determined by mechanical effects. This has been shown by the loss of extremity bone mass in patients with paraplegia (more than 40%). Modeling occurs by separate formation and resorption drifts to reshape, thicken, and strengthen a bone or trabecula by moving its surfaces around in tissue space. Remodeling also involves both resorption and formation of bone. BMUs turn bone over in small packets through a process in which an activating event causes some bone resorption and bone formation is following

### Mechanotransduction of Osteoblasts

It is generally suggested that forces leading to cellular deformation are signaled to the cellular genome through mechanotransduction (Meyer, U. et al. J Craniomaxillofac Surg 32, 140-9 (2004)). Mechanotransduction, or the conversion of a biophysical force into a cellular response, is an essential mechanism in bone biology. It allows bone cells to respond to a changing mechanical environment.

Mechanotransduction can be categorized in an idealized manner into (1) mechanocoupling, which means the transduction of mechanical force applied to the tissue into a local mechanical signal perceived by a bone cell; (2) biochemical coupling, the transduction of a local mechanical signal into biochemical signal cascades altering gene expression or protein activation; (3) transmission of signals from the sensor cells to effector cells, which actually form or remove bone; and ultimately (4) the effector cell response.

When loads are applied to bone, the tissue begins to deform causing local strains (typically reported in units of microstrain; 10,000 microstrain=1% change in length). It is well known that osteoblasts and osteocytes act as the sensors of local bone strains and that they are appropriately located in the bone for this function.

### In Vitro Mechanical Stimulation

The ability of living tissues to remodel in response to cyclic loads suggests that similar adaptive processes may occur in engineered tissues in vitro. Since the early work of Glucksmann in 1939 (Glucksmann A. Anatomical Record 73:39-56 (1939)), a vast array of stimulation devices have been constructed to load cells in compression, tension, bending, out-of-plane distension, in-plane distention, shear, and combinations of the above (recently reviewed by Brown). A number of studies have shown that mechanically challenged tissue constructs show hypertrophy and increased orientation of fibers and cells in comparison to control constructs. Fink et al subjected cells in a collagen gel to cyclic stretch at 1.5 Hz and observed significant changes in cell arrangement into parallel arrays, increases in cell length and width, and increases in myochondrial density. Functionally, the tissue had a contractile force 2-4 times that of the control (Fink, C; et al., Faseb Journal 14(5):669-79 (2000)). Buschmann et al found increased extracellular matrix biosynthesis in collagenous tissues by subjecting chondrocytes in an agarose gel to 3% strain at 0.01-1.0 Hz (Buschmann, MD; et al., Journal of Cell Science, 108 (Pt 4):1497-508 (1995)). Zeichen et al found increased cell proliferation by cyclically stretching the cells 5% strain (50,000 microstrains) at 1 Hz for 15-60 minutes (Zeichen, J; et al., American Journal of Sports Medicine 2000 November-December, 28(6):888-92). Similarly, Desrosiers et al reported significant increase in cell proliferation, collagen synthesis, and proteoglycan synthesis by 10% strain (100,000 microstrains) at 0.1 Hz for 24 hours on an elastomeric substrate and (Desrosiers, E. A., et al., Ann. Chir 49, 768-774 (1995)).

### High Frequency Effects

It has long been known that low strain, high frequency stimulation (e.g. 50 με @ 30 Hz) can induce similar (Qin, Y. X., et al., J. Orthop. Res. 16, 482-489 (1998)), if not more (Hsieh Y. F. and Turner C. H., Journal of Bone and Mineral Research 16:918-924 (2001)), stimulatory effects than high strain low frequency (e.g. 1,000 με 1 Hz). Recently, Rubin et al. uncovered evidence that brief applications (e.g. 10 minutes) of barely perceptible vibrations at high frequencies (e.g. 0.25 g @ 90 Hz) stimulated bone growth better than weight-bearing activity for the same duration (Rubin C, et al., FASEB J. 15(12):2225-9). Osteoblast response to low frequency, high loads has been shown (Tanaka, S. M., et al., Journal of Biomechanics, 36(1):73-80 (2003)) to be sensitized by high frequency (50 Hz), low amplitude signals through a phenomenon termed stochastic resonance which has been reported by Collins et al. (Collins J. J., Imhoff T. T. and Grigg P. Noise-enhanced tactile sensation. Nature 1996, 383:770) to enhance the sensitivity of mechanoreceptors.

### Tooth Repositioning

Static Force Systems

Continuously applied static forces have been studied and/or used in previous studies and clinical practice in orthodontics. Continuously applied static forces are used on a daily basis for orthodontic tooth movement in these patients. Day-to-day practice of application of continuously applied static forces in clinical orthodontics, orthodontic tooth movement has been simulated in animal models with elastics and coil springs (Reitan, Acta Odont. Scand. Suppl., 6:1-240 (1951); Storey et al., (1952) Aust. J. Dent., 56:11-18; Pygh et al., (1982) In Berkivitz et al. (Eds) The Periodontal Ligament in Health and Disease, Pergamon Press, Oxford, England, pp. 269-290; Jager et al., (1993) Histochemistry, 100:161-166; Ashizawa et al., (1998) Arch Oral Biol., 43(6):473-484; Gu et al., (1999 Angle Orthod. 69(6):515-522; Melsen (1999) Angle Orthod., 69(2):151-158; Terai et al., (1999) J. Bone Miner. Res., 14(6): 839-849; Tsay et al., (1999) Am. J. Orthod. Dentofacial Orthop., 115(3):323-330; and Verna (1999) Bone, 24(4):371-379].

Threshold force and the duration of force application are two fundamental concepts in the art of orthodontics. A minimum of 6 hours was proposed to be the threshold below which orthodontic tooth movement does not occur (Proffit et al., Mosby Year Book: St. Louis. pp. 266-288 (1993)). However, this projected minimum threshold of 6 hours per day by Proffit et al. is largely theoretical, as stated in the caption of FIGS. 9-12 on page 275 of that work. Empirical clinical experience appears to support the notion that orthodontic forces must be applied beyond certain daily duration in order to induce tooth movement, the precise minimum daily duration is unclear. What appears of more significance than daily minimum duration is the overall duration of orthodontic treatment in association with current technology.

The precise threshold force magnitude required for tooth movement has not yet to be determined. In general a few hundred grams of force have been implicated to be the threshold for tooth movement. However, there remain projections as “theoretically, there is no doubt that light continuous forces produce the most efficient tooth movement” [Proffit et al., (1993) Mosby Year Book: St. Louis. pp. 266-288]. It has been shown that proliferation of periodontal ligament cells is greater in response to continuous forces than to intermittent forces of the same magnitude (Reitan, Acta Odont. Scand. Suppl., 6:1-240 (1951). These intermittent forces were static forces applied intermittently over time (Reitan, 1951, supra; van Leeuwen et al., Eur. J. Oral Sci., 107(6):468-474 (1999)).

Non-Static Forces

Intermittent forces were used in orthodontic treatment of malocclusion. The nature of the intermittent forces was static forces applied intermittently over time, for instance, two hours on and two hours off (Reitan, 1951, supra; van Leeuwen et al., (1999) Eur. J. Oral Sci., 107(6):468-474). Cyclic force systems were also described in U.S. Pat. Nos. 6,648,639 and 6,832,912 to Mao et al. However, the cyclic force systems are impractical to use. A cyclic force system using cyclic forces generated by a motor for treating tooth malocclusion is described U.S. Pat. Nos. 6,832,912 and 6,648,639, the teachings of which are incorporated herein by reference.

### Transduction Cyclic Force

In accordance with one aspect of the present invention, cyclic forces are generated through transducer shells and used to expedite the remodeling of tooth or teeth. Thus, this invention concerns the remodeling of a mammal's face by realigning one or more of the mammal's teeth. Exemplary mammals are humans, apes, monkeys, rabbits, mice, rats and other laboratory animals as well as companion animals such as cats and dogs, and livestock such as pigs, goats, horses, cattle, sheep and the like.

As used herein, the term “transducer shell” refers to an orthodontic force system that includes at least one transducer material (e.g., piezoelectric crystals or an amount of a piezoelectric compound or material). The force system can take any form suitable for use in orthodontics. In some embodiments, the force system includes the geometry of a tooth that requires of an orthodontic treatment. Such force systems can be fixed or movable.

The term “tooth” and “teeth” are used interchangeably.

Some examples of the force systems can take the form of, for example, shells, rings, or toothlock. Some further examples of the force system can be generally referred to as geometries.

In some embodiments, the force system can be multiple teeth (entire arch or partial arch) stimulation, which include, but are not limited to, mouthguard like device, palatal expander like device, retainer like device, bleaching tray like device, or bleaching-strip-like device that adhere to teeth.

In some further embodiments, the force system can be single tooth stimulation, which include, but are not limited to, tooth-colored, tooth-form shells; and transparent or translucent, tooth-form shells.

In some embodiments, the force system can be non-tooth-form shells that are bonded to the tooth and can also be used, if desired, as leveraging structures for orthodontic movement. This allows conventional wires or elastics or computer devices and aligners to be adapted to include the transduction force system described herein.

Transducer Materials

The transducer material or compound that can be used to provide for the cyclic force system includes any transducer material, either known or will become known in the future. Some exemplary transducer materials or compounds include, but are not limited to, materials in the general categories of piezoelectric crystals, ceramics, polymers, magneostrictive alloys, and electrostrictive ceramics. Examples of common piezoelectric crystals include quartz, barium titanate, lithium niobate, rochelle salt, ammonium dihydrogen phosphate, potassium dihydrogen phosphate, tourmaline, zinc blende, lithium tantalate, and bismuth germanium oxide. Common piezoelectric ceramics include barium titanate, lead titanate, lead zirconate, lead metanicbate, and lead zirconate titanate. Piezoelectric polymers are exemplified by polyvinylidene fluoride and their copolymers with trifluoroethylene and tetraflouoroethylene, polyamides, polyureas, and liquid crystal polymers, and amorphous polymers such as polyacrylonitrile, poly(vinylidenecyanide vinylacetate, polyvinyl chloride, polyvinyl acetate, polyphenylethernitrile, poly(9,9-di-n-octylfluorenyl-2,7-vinylene) (PFV), poly(benzyl glutamate), poly(methyl glutamate), cellulose triacetate, poly(propylene oxide), poly(1-bicyclobutanecarbonitrile) and combinations thereof. Electrostrictive ceramics such as lead magnesium niobate-lead titanate and magnetostrictive materials such as terbium dysprosium iron (Terfenol-D), and terbium dysprosium can also be used for the said applications.

Some examples of piezoelectric crystals, ceramic materials or compositions include, but are not limited to, LiNbO₃, LiTaO₃, BaTiO₃, PbTiO₃, PbZrO₃, Pb₂Nb₂O₆, and combinations thereof. In some embodiments, the ceramics can be a compound of two or more ceramics, some embodiments of these ceramic compounds include, but are not limited to, Pb(Mg_{1/3}Nb_{2/3})TiO₃—PbTiO₃—PbZrO₃, Na_{0.5}K_{0.5}NbO₃, Pb_{0.6}Ba_{0.4}Nb₂O₆, Pb(Zr_{0.55}Ti_{0.45})O₃, Pb_{0.99}Ca_{0.01}(Zr_{0.53}Ti_{0.47})O₃, Pb_{0.95}Ca_{0.05}(Zr_{0.53}Ti_{0.47})O₃, Pb_{0.92}Ca_{0.08}(Zr_{0.53}Ti_{0.47})O₃, Pb_{0.99}Sr_{0.01}(Zr_{0.53}Ti_{0.47})O₃, Pb_{0.95}Sr_{0.05}(Zr_{0.53}Ti_{0.47})O₃, Pb_{0.90}Sr_{0.10}(Zr_{0.53}Ti_{0.47})O₃, Pb_{0.85}Sr_{0.15}(Zr_{0.53}Ti_{0.47})O₃, Pb_{0.80}Sr_{0.20}(Zr_{0.53}Ti_{0.47)O}₃, Pb_{0.875}Sr_{0.125(Zr}_{0.56}Ti_{0.44})O₃, and combinations thereof.

In some embodiments, the transducer material can be a transducer composite material. The composite can be a transducer material and a non-transducer material. The non-transducer material can be any biocompatible material, which can be polymer or a non-polymer. In some embodiments, the polymer can be polyolefin such as rubber, polyester, epoxy polymer, rubber, etc., and the non-polymer can be, e.g., glass, carbon fiber, glass fiber, glass spheres, silica, alumina, ceramics, etc. Some exemplary composite materials include, but are not limited to Pb(Zr,Ti)O₃ (PZT), PZT-epoxy, PZT-rubber, PZT-epoxy with glass spheres, PbTiO₃-rubber, and combinations thereof.

In some embodiments, the transducer material can exclude any of the above crystals, ceramics, polymers, and/or composites.

Force Frequency

The frequency of cyclic force of the device described herein can be determined by the transducer material used. Each transducer material or compound has a frequency, which is well documented in the art. Some exemplary frequencies of piezoelectric compounds are can be found at Yuhuan Xu, Ferroelectric Materials and Their Applications, North Holland, 1991, Amsterdam, London, New York, Tokyo.

The magnitude of cyclic force of the device described herein can be determined by the amount of the transducer compound or material used in the device. The cyclic force can be aligned to any of the x, y, or z direction or any of the planes that can be defined by a set of coordinates (x,y,z). For example, to align the cyclic force to a given direction or plane, the opposite direction or plane of the device can be fixed or locked to a tooth or teeth such that the cyclic force can act on the given direction or plane. One of ordinary skill in the art would determine, according to a given prescription, to choose an amount of one or more transducer compound/material for forming the device defined herein or to select a formed device containing an amount of one or more transducer compound(s)/material(s).

In some embodiments, the systems provided herein is capable of providing a cyclic force having a frequency above about 0.001 Hz, above about 0.01 Hz, above about 0.1 Hz, above about 1 Hz, above about 2 Hz, above about 10 Hz, above about 20 Hz, above about 40 Hz (for example, 40.1 Hz or above), or above about 1 00 Hz. Some exemplary ranges of frequency are from about 0.001 Hz to about 100,000 Hz, from about 0.01 Hz to about 100,000 Hz, from about 1 Hz to about 100,000 Hz, from about 5 Hz to about 100,000 Hz, from about 20 Hz to about 100,000 Hz, from about 40 Hz (e.g., 40.1 Hz) to about 100,000 Hz, from about 100 Hz to about 100,000 Hz, from about 0.01 Hz to about 100 Hz, from about 1 Hz to about 100 Hz, from about 2 Hz (e.g., 2.1 Hz) to about 100 Hz, from about 5 Hz to about 100 Hz, from about 20 Hz to about 100 Hz, from about 10 Hz to about 100 Hz, from about 40 Hz (e.g., 40.1 Hz) to about 100 Hz, from about 1 Hz to about 40 Hz, from about 10 Hz to about 40 Hz, from about 20 Hz to about 40 Hz.

In some embodiments, the systems provided herein can specifically exclude any of the above mentioned frequencies or frequency ranges.

In some embodiments, the system described herein is capable of providing a cyclic force having a magnitude in the range between about 0.001 Newton to about 20 Newton, e.g., about 0.001 Newton, about 0.005 Newton, about 0.01 Newton, about 0.02 Newton, about 0.03 Newton, about 0.04 Newton, about 0.05 Newton, about 0.06 Newton, about 0.07 Newton, about 0.08 Newton, about 0.09 Newton, about 0.1 Newton, about 0.2 Newton, about 0.3 Newton, about 0.4 Newton, about 5 Newton, about 0.6 Newton, about 0.7 Newton, about 0.8 Newton, about 0.9 Newton, about 1 Newton, about 2 Newton, about 3 Newton, about 4 Newton, about 5 Newton, about 6 Newton, about 7 Newton, about 8 Newton, about 9 Newton, about 10 Newton, or about 15 Newton.

In some embodiments, the cyclic force system described herein is capable of generating a load of ranging from about 0.1 microstrain to about 1,000,000 microstrains. For example, the cyclic force system is capable of generating a load of about 0.2, about 0.5, about 1, about 5, about 10, about 50, about 100, about 200, about 300, about 400, about 500, about 600, about 700, about 800, about 900, about 1,000, about 2,000, about 3,000, about 4,000, about 5,000, about 6,000, about 7,000, about 8,000, about 9,000, about 10,000, about 15,000, about 20,000, about 25,000, about 30,000, about 35,000, about 40,000, about 45,000, about 50,000, about 55,000, about 60,000, about 65,000, about 70,000, about 75,000, about 80,000, about 85,000, about 90,000, about 95,000, about 100,000, about 250,000, about 300,000, about 350,000, about 400,000, about 450,000, about 500,000, about 550,000, about 600,000, about 650,000, about 700,000, about 750,000, about 800,000, about 850,000, about 900,000, or about 950,000 microstrains.

In some embodiments, the systems provided herein can specifically exclude any of the above mentioned loads or force magnitudes.

In some embodiments, where the system is used for orthodontic tooth/teeth movement, the systems provided herein can specifically exclude any of the frequencies, magnitudes, and/or loads described above. For example, in these embodiments, where the cyclic force is aligned in a direction of desired alignment, the system can specifically exclude one or both of the following: the frequency of the cyclic force in the range between 0.1 Hz and 2 Hz or between 0.1 Hz and 40 Hz, or the magnitude up to 10 Newton or in the range between 0.1 and 5 Newton.

### Examples of Device

In some embodiments, the device described herein is an orthodontic device such as an orthodontic tray or set of trays. The tray or set of trays can be made according to methods well documented in the art, which can be a computer aided process or a traditional process as described in, for example, U.S. Pat. Nos. 6,554,611; 6,398,548; and 6,454,565 and U.S. application Publication No. 20040265770, the teachings of which are described herein by reference.

In some embodiments, the device is a device for multiple teeth (entire arch or partial arch) stimulation. Such devices include, but are not limited to, mouthguard like device, palatal expander like device, retainer like device, bleaching tray like device, bleaching-strip-like device that adhere to teeth.

In some embodiments, the device is a device for single tooth stimulation. Such devices include, but are not limited to, tooth-colored, tooth-form shells; transparent or translucent, tooth-form shells;

In some embodiments, non-tooth-form shells or geometry that are bonded to the tooth and can also be used, if desired, as leveraging structures for orthodontic movement. Such non-tooth-form shells or geometries can be affixed to a conventional tooth treating devices (e.g., tooth trays or shells) for facilitating tooth movement.

### Method of Use

The cyclic force system provided herein can be used in a variety of applications. The method includes the steps of (a) applying a cyclical force to at least one tooth of a mammal, and (b) repeating step (a) a plurality of times until a desired or predetermined result is obtained. An exemplary application of the force system is orthodontics for moving tooth/teeth to a predetermined position.

In these embodiments, the features of the cyclic forces are described above.

In some embodiments, the cyclic force can be used with a realigning force (e.g., a static force) in the direction of tooth/teeth realignment.

While the above is a complete description of the preferred embodiments of the invention, various alternatives, modifications, and equivalents may be used. Therefore, the above description should not be taken as limiting the scope of the invention which is defined by the appended claims.

1. A device for moving a tooth or teeth to a predetermined position or stimulating a tooth or teeth, comprising:
a transducer material capable of generating a cyclic force upon exposure to a stimulus,
wherein the device optionally provides a realigning force in a direction of desired realignment of the tooth or teeth.

2. The device of claim 1, which is a transducer shell.

3. The device of claim 1, wherein the cyclic force has a magnitude above about 0.001 Newton.

4. The device of claim 3, wherein the cyclic force has a frequency above about 0.001 Hz.

5. The device of claim 3, wherein the transducer material is selected from the group consisting of piezoelectric crystals, ceramics, polymers, magneostrictive alloys, electrostrictive ceramics, and combinations thereof.

6. The device of claim 1, wherein the stimulus is a magnetic field or electric current, and
wherein electric current is generated by a battery cell in the device.

7. The device of claim 5, which is a transducer shell.

8. The device of claim 1, which is an orthodontic tray or a set of orthodontic trays.

9. (canceled)

10. The device of claim 9, which is a selected from mouthguard like device, palatal expander like device, retainer like device, bleaching tray like device, or bleaching-strip-like device that adhere to teeth.

11. (canceled)

12. The device of claim 11, which is selected from the group consisting of tooth-colored, tooth-form shells and transparent or translucent, tooth-form shells.

13. The device of claim 1, which is attached to a conventional orthodontic device for tooth movement.

14. A method of forming a device for realigning teeth, comprising
providing a transducer material, and
forming the device comprising the transducer material.

15. The method of claim 14, wherein the device comprises a transducer shell.

16. The method of claim 14, wherein the cyclic force has a magnitude above about 0.001 Newton.

17. A method for moving a tooth or teeth to a predetermined position, comprising:
a) applying to the tooth or teeth a cyclic force having a frequency above 0.001 Hz,
b) providing a realigning force to move the tooth or teeth toward the predetermined position,
c) repeating the cyclic force on the tooth or teeth a plurality of times until the tooth or teeth are moved to the predetermined position,
wherein the cyclic force is aligned in any direction defined by x, y, z coordinates, and
wherein, if the cyclic force is in the direction of realignment of the tooth or teeth, the cyclic force is defined by any of the following:
the frequency of the cyclic force is not in the range between 0.1 Hz and 40 Hz if the cyclic force has a magnitude up to 10 Newton or vice versa; or
the frequency of the cyclic force is not in the range between 0.1 Hz and 2 Hz if the cyclic force has a magnitude in the range between 0.1 and 5 Newton or vice versa.

18. The method of claim 17, wherein the cyclic force is generated by a device according to claim 1.

19-31. (canceled)

32. A method of forming a device for stimulating or moving a tooth or teeth, comprising
providing a transducer material, and
forming the device comprising the transducer material.

33. The method of claim 32, wherein the device comprises a transducer shell.

34. The method of claim 32, wherein the cyclic force has a magnitude above about 0.001 Newton.

35. A method for moving or stimulating a tooth or teeth, comprising:
a) applying to the tooth or teeth a cyclic force having a frequency above 0.001 Hz and a realigning force in a direction of desired realignment of the tooth or teeth to a predetermined position, and
b) repeating the cyclic force on the tooth or teeth a plurality of times until the tooth or teeth are moved to the predetermined position,
wherein the cyclic force is aligned in any direction defined by x, y, z coordinates.

36. The method of claim 35, wherein the cyclic force is generated by a device according to claim 1.
